(19) United States
(12) Patent Application Publication
(10) Pub. No.: US 2023/0042130 A1
(43) Pub. Date: Feb. 9, 2023

(54) Wireless Optical Communication Method and Related Apparatus

(71) Applicant: Huawei Technologies Co., Ltd., Shenzhen (CN)

(72) Inventor: Junping Zhang, Shenzhen (CN)

(21) Appl. No.: 17/965,332

(22) Filed: Oct. 13, 2022

Related U.S. Application Data
(63) Continuation of application No. PCT/CN2021/086603, filed on Apr. 12, 2021.

(30) Foreign Application Priority Data
Apr. 14, 2020 (CN) 202010289899.9

(51) Int. Cl. G02B 26/08; H02J 50/30

(52) U.S. Cl. CPC G02B 26/0816; H02J 50/30

(57) ABSTRACT

A network device generates first resonant light used to carry information; and the network device sends the first resonant light to a terminal by using a resonant cavity component, where the resonant cavity component of the network device and a resonant cavity component of the terminal form an open resonant cavity. In wireless optical communication, an information transmission rate can be greatly improved by using a resonant light multiplexing technology. This application further discloses a network device and a terminal that can implement the foregoing wireless optical communication method.

### CROSS-REFERENCE TO RELATED APPLICATIONS

This application is a continuation of International Application No. PCT/CN2021/086603, filed on Apr. 12, 2021, which claims priority to Chinese Patent Application No. 202010289899.9, filed on Apr. 14, 2020. The disclosures of the aforementioned applications are hereby incorporated by reference in their entireties.

### TECHNICAL FIELD

This application relates to the field of communication technologies, and in particular, to a wireless optical communication method and a related apparatus.

### BACKGROUND

A wireless optical communication technology refers to a communication technology that uses free space as a transmission channel and uses light for data transmission. The wireless optical communication technology is also referred to as free space optical (FOS) communication, and may be classified into atmospheric laser communication, underwater laser communication, and the like based on a type of the free space.

Currently, there is an optical communication method based on a light emitting diode (LED). A transmit end has an LED emitting light source. After an optical modulator modulates LED light and information, the transmit end sends the modulated LED light to a receive end. The receive end converts the LED light into an electrical signal by using a photodetector, and then decodes, demodulates, and equalizes the electrical signal to obtain the foregoing information.

However, a bandwidth that can be used to modulate the LED light is only tens of megabytes. This imposes a high limitation on an information transmission rate and makes it difficult to implement high-speed communication.

### SUMMARY

In view of this, this application discloses a wireless optical communication method and a related apparatus, to improve an information transmission rate of wireless optical communication.

According to a first aspect, a wireless optical communication method is disclosed. In the method, after generating first resonant light used to carry information, a network device sends the first resonant light to a terminal by using a resonant cavity component. The resonant cavity component of the network device and a resonant cavity component of the terminal form an open resonant cavity. After light transmitted by the network device and the terminal is input into the open resonant cavity, the light resonates in the open resonant cavity, and the resonant light is emitted from an output end of the open resonant cavity to form laser light to be received by a receive end.

The first resonant light may be obtained by modulating information and light of several wavelengths, and light of each wavelength is used as an independent information channel. Because an available bandwidth of the resonant light is far greater than an available bandwidth of LED light, a transmission capability of the resonant light is far greater than a transmission capability of the LED light, so that an information transmission rate is greatly improved. In addition, brightness of the resonant light is far less than brightness of laser light. Therefore, the resonant light is safer than the laser light, and a risk of human eye injury is reduced.

It should be noted that two resonant cavity components may be configured for both of the network device and the terminal. One resonant cavity component is configured to transmit the resonant light, and the other resonant cavity component is configured to receive the resonant light. In this way, the network device may receive the first resonant light sent by the terminal by using the other resonant cavity component. Information carried in the first resonant light may be instructions, data, or the like.

In a possible implementation, the method further includes: The network device sends second resonant light to the terminal by using the resonant cavity component, where the second resonant light is used for charging. In this way, the network device may further charge the terminal. The first resonant light and the second resonant light are at different time intervals. A unit of a time interval may be a slot, a subframe, a frame, a millisecond, a second, a minute, an hour, or the like. A length of the time interval may be one or more slots, one or more subframes, one or more frames, one or more milliseconds, one or more seconds, one or more minutes, or one or more hours. This may be specifically set based on an actual requirement, and is not limited herein. In this way, the network device may implement two functions: a communication function and a charging function by using time division multiplexing of the resonant light, and the two functions may be implemented by using a same resonant cavity. It should be noted that power for sending the second resonant light by the network device is greater than power for sending the first resonant light by the network device.

In another possible implementation, the terminal sends a charging request to the network device when a battery capacity is less than or equal to a first threshold. After receiving the charging request sent by the terminal, the network device adjusts a communication mode to a charging mode based on the charging request, and then the network device sends the second resonant light to the terminal. The charging request is a type of information carried in the first resonant light.

In another possible implementation, the terminal sends a charging request to the network device when a communication function is in an idle state, the network device adjusts a communication mode to a charging mode based on the charging request, and then the network device sends the second resonant light to the terminal. The charging request is a type of information carried in the first resonant light.

In another possible implementation, when duration in which the network device sends the second resonant light is greater than or equal to first preset duration, the network device adjusts a charging mode to a communication mode. When duration in which the terminal receives the second resonant light is greater than or equal to the first preset duration, the terminal adjusts a charging mode to a communication mode, and the terminal sends an indication to the network device. After the network device receives the indication sent by the terminal, the network device can communicate with the terminal. The indication indicates that the terminal is in the communication mode. The first preset duration may be charging duration in which a battery capacity of the terminal is from a first threshold to a second threshold. When the battery capacity is less than or equal to the first threshold, the battery capacity is insufficient to support the communication function. When the battery capacity is greater than the first threshold, the battery capacity can support the communication function. When the battery capacity is greater than or equal to the second threshold, it indicates that charging is completed. Alternatively, the first preset duration may be charging duration in which the battery capacity of the terminal is from zero to the second threshold, or may be a value that is set based on an actual situation. This is not limited herein.

In another possible implementation, when duration in which the network device sends the second resonant light is greater than or equal to second preset duration, the network device adjusts a charging mode to a communication mode. When duration in which the terminal receives the second resonant light is greater than or equal to the second preset duration, the terminal adjusts a charging mode to a communication mode. When the terminal needs to send service data, the terminal sends an indication to the network device. After the network device receives the indication sent by the terminal, the network device receives the service data sent by the terminal. The indication indicates that the terminal is in the communication mode. When the duration in which the terminal receives the second resonant light is greater than or equal to the second preset duration, it indicates that the battery capacity of the terminal is greater than the first threshold, and can support the communication function. In this way, the network device and the terminal may automatically adjust to the communication mode to transmit the service data.

According to a second aspect, a wireless optical communication method is provided. In the method, a terminal receives, by using a resonant cavity component, first resonant light that is sent by a network device and that is used to carry information, and the resonant cavity component of the terminal and a resonant cavity component of the network device form an open resonant cavity. Both of the network device and the terminal have a light emitting unit. After light transmitted by the light emitting unit is input into the open resonant cavity, the light resonates in the open resonant cavity, and the resonant light is emitted from an output end of the open resonant cavity to form laser light to be received by a receive end.

The first resonant light may be obtained by modulating information and light of several wavelengths, and light of each wavelength is used as an independent information channel. Because an available bandwidth of the resonant light is far greater than an available bandwidth of LED light, a transmission capability of the resonant light is far greater than a transmission capability of the LED light, so that an information transmission rate is greatly improved. In addition, brightness of the resonant light is far less than brightness of laser light. Therefore, the resonant light is safer than the laser light.

It should be noted that two resonant cavity components may be configured for both of the network device and the terminal. One resonant cavity component is configured to transmit the resonant light, and the other resonant cavity component is configured to receive the resonant light. In this way, the terminal may also send the first resonant light to the network device by using the other resonant cavity component. Information carried in the first resonant light may be instructions, data, or the like.

In a possible implementation, the method further includes: The terminal receives, by using the resonant cavity component, second resonant light sent by the network device, where the second resonant light is used for charging. In this way, the network device may further charge the terminal. The first resonant light and the second resonant light are at different time intervals. A unit of a time interval may be a slot, a subframe, a frame, a millisecond, a second, a minute, an hour, or the like. A length of the time interval may be set based on an actual requirement, and is not limited herein. In this way, the network device may implement two functions: a communication function and a charging function by using time division multiplexing of the resonant light, and the two functions may be implemented by using a same resonant cavity. It should be noted that power for sending the second resonant light by the network device is greater than power for sending the first resonant light by the network device.

In another possible implementation, when the terminal detects that a battery capacity is less than or equal to a first threshold, the terminal adjusts a communication mode to a charging mode, and sends a charging request to the network device, where the charging request indicates the network device to adjust the communication mode to the charging mode. When the terminal detects that the battery capacity is less than or equal to the first threshold, it indicates that the current battery capacity is excessively low. In this case, the terminal sends the charging request to the network device, so that an automatic charging function can be implemented. When the battery capacity of the terminal is greater than the first threshold, it indicates that the battery capacity is sufficient to support the communication function.

In another possible implementation, when the terminal detects that a communication function is in an idle state, the terminal adjusts a communication mode to a charging mode, and sends a charging request to the network device, where the charging request indicates the network device to adjust the communication mode to the charging mode. In this way, the terminal can be automatically charged when not performing communication, so that a battery life of the terminal is improved, and user experience is improved.

In another possible implementation, when duration in which the second resonant light is received is greater than or equal to first preset duration, the terminal adjusts a charging mode to a communication mode; and the terminal sends an indication to the network device, where the indication indicates that the terminal is in the communication mode. When the duration in which the second resonant light is received is greater than or equal to the first preset duration, it indicates that a current battery capacity can meet a communication requirement or charging is completed. In this case, the network device stops sending the second resonant light according to the indication, to reduce invalid power consumption.

In another possible implementation, when duration in which the second resonant light is sent is greater than or equal to second preset duration, the network device adjusts a charging mode to a communication mode. When duration in which the terminal receives the second resonant light is greater than or equal to the second preset duration, the terminal adjusts a charging mode to a communication mode. When the terminal needs to send service data, the terminal sends an indication to the network device, where the indication indicates that the terminal is in the communication mode; and the terminal sends the service data to the network device. Optionally, after the terminal adjusts the charging mode to the communication mode, the terminal may skip a step of sending the indication, and send the service data to the network device. In another optional implementation, after receiving the indication, the network device sends an adjustment completion message to the terminal, and the terminal sends the service data to the network device based on the adjustment completion message.

According to a third aspect, a network device is disclosed. The network device includes a receiving unit, a processing unit, and a sending unit, and both of the receiving unit and the sending unit include a resonant cavity component; the processing unit is configured to generate first resonant light used to carry information; and the sending unit is configured to send the first resonant light to a terminal, where a resonant cavity component of the network device and a resonant cavity component of the terminal form an open resonant cavity.

In a possible implementation, the sending unit is further configured to send second resonant light to the terminal, where the second resonant light is used for charging.

In another possible implementation, the first resonant light and the second resonant light are at different time intervals.

In another possible implementation, the receiving unit is configured to: before the sending unit sends the second resonant light to the terminal, receive a charging request sent by the terminal, where the charging request is sent by the terminal when a battery capacity is less than or equal to a first threshold; and the processing unit is further configured to adjust a communication mode to a charging mode based on the charging request.

In another possible implementation, the receiving unit is configured to: before the sending unit sends the second resonant light to the terminal, receive a charging request sent by the terminal, where the charging request is sent by the terminal when a communication function is in an idle state; and the processing unit is further configured to adjust a communication mode to a charging mode based on the charging request.

In another possible implementation, the processing unit is further configured to: when duration in which the second resonant light is sent is greater than or equal to first preset duration, adjust a charging mode to a communication mode; and the receiving unit is further configured to receive an indication sent by the terminal, where the indication indicates that the terminal is in the communication mode.

In another possible implementation, the processing unit is further configured to: when duration in which the second resonant light is sent is greater than or equal to second preset duration, adjust a charging mode to a communication mode; the receiving unit is further configured to receive an indication sent by the terminal, where the indication indicates that the terminal is in the communication mode; and the receiving unit is further configured to receive service data sent by the terminal.

For specific implementation steps of the third aspect and the possible implementations of the third aspect performed by the composition modules of the apparatus provided in the third aspect of this application, and beneficial effects brought by each implementation, refer to the descriptions in the first aspect and the possible implementations of the first aspect. Details are not described herein again.

According to a fourth aspect, a terminal is disclosed. The terminal includes a receiving unit, a processing unit, and a sending unit, and both of the receiving unit and the sending unit include a resonant cavity component; and the receiving unit is configured to receive first resonant light that is sent by a network device and that is used to carry information, where a resonant cavity component of the terminal and a resonant cavity component of the network device form an open resonant cavity.

In another possible implementation, the receiving unit is further configured to receive second resonant light sent by the network device, where the second resonant light is used for charging.

In another possible implementation, the processing unit is configured to: when a battery capacity is less than or equal to a first threshold, adjust a communication mode to a charging mode; and the sending unit is configured to send a charging request to the network device, where the charging request indicates the network device to adjust the communication mode to the charging mode.

In another possible implementation, the processing unit is configured to: when detecting that a communication function is in an idle state, adjust a communication mode to a charging mode; and the sending unit is further configured to send a charging request to the network device, where the charging request indicates the network device to adjust the communication mode to the charging mode.

In another possible implementation, the processing unit is configured to: when duration in which the second resonant light is received is greater than or equal to first preset duration, adjust a charging mode to a communication mode; and the sending unit is further configured to send an indication to the network device, where the indication indicates that the terminal is in the communication mode.

In another possible implementation, the processing unit is configured to: when duration in which the second resonant light is received is greater than or equal to second preset duration, adjust a charging mode to a communication mode; the sending unit is further configured to send an indication to the network device when service data needs to be sent, where the indication indicates that the terminal is in the communication mode; and the sending unit is further configured to send the service data to the network device.

For specific implementation steps of the second aspect and the possible implementations of the second aspect performed by the composition modules of the apparatus provided in the fourth aspect of this application, and beneficial effects brought by each implementation, refer to the descriptions in the first aspect and the possible implementations of the first aspect. Details are not described herein again.

A fifth aspect discloses a wireless optical communication system. The wireless optical communication system includes a network device and a terminal. The network device is configured to: generate first resonant light used to carry information; and send the first resonant light to the terminal, where a resonant cavity component of the network device and a resonant cavity component of the terminal form an open resonant cavity; and the terminal is configured to receive the first resonant light sent by the network device.

For steps performed by the network device in the fifth aspect of this application and beneficial effects, refer to the descriptions in the first aspect and the possible implementations of the first aspect. For steps performed by the terminal in the fifth aspect and beneficial effects, refer to the descriptions in the second aspect and the possible implementations of the second aspect. Details are not described herein again.

According to a sixth aspect, a computer-readable storage medium is provided. The computer-readable storage medium stores a computer program. When the computer program runs on a computer, the computer is enabled to perform the wireless optical communication method in the first aspect or the wireless optical communication method in the second aspect.

According to a seventh aspect, a computer program is provided. When the computer program runs on a computer, the computer is enabled to perform the wireless optical communication method in the first aspect or the wireless optical communication method in the second aspect.

According to an eighth aspect, a chip system is provided. The chip system includes a processor, configured to support a base station in implementing functions in the foregoing aspects, for example, sending or processing data and/or information in the foregoing methods. In a possible design, the chip system further includes a memory, and the memory is configured to store program instructions and data that are necessary for the wireless optical communication method. The chip system may include a chip, or may include a chip and another discrete component.

### BRIEF DESCRIPTION OF THE DRAWINGS

FIG. 1 is a schematic diagram of a wireless optical communication system according to an embodiment of this application;

FIG. 2 is a diagram of a structure of an optical processing module of a network device according to an embodiment of this application;

FIG. 3 is a diagram of a structure of an optical processing module of a terminal according to an embodiment of this application;

FIG. 4 is a flowchart of a wireless optical communication method according to an embodiment of this application;

FIG. 5 is another flowchart of a wireless optical communication method according to an embodiment of this application;

FIG. 6 is another flowchart of a wireless optical communication method according to an embodiment of this application;

FIG. 7 is another flowchart of a wireless optical communication method according to an embodiment of this application;

FIG. 8 is another flowchart of a wireless optical communication method according to an embodiment of this application;

FIG. 9 is another diagram of a structure of a network device according to an embodiment of this application; and

FIG. 10 is another diagram of a structure of a terminal according to an embodiment of this application.

### DETAILED DESCRIPTION OF ILLUSTRATIVE EMBODIMENTS

A wireless optical communication method in this application may be applied to a wireless optical communication system. The wireless optical communication system may be deployed in an indoor scenario, may be deployed in an outdoor scenario in which a terminal can perform direct line-of-sight communication with a base station, or may be deployed in an industrial control scenario or an Internet of things (IoT) scenario.

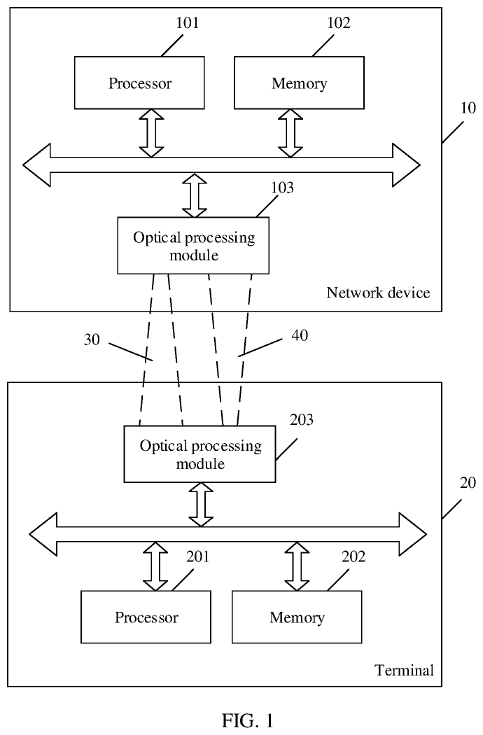

FIG. 1 is a schematic diagram of a wireless optical communication system. Refer to FIG. 1. The wireless optical communication system may include a network device 10 and a terminal 20. The network device 10 includes a processor 101, a memory 102, and an optical processing module 103. The terminal 20 includes a processor 201, a memory 202, and an optical processing module 203. It may be understood that the network device 10 and the terminal 20 may further include but are not limited to an input/output apparatus, a network interface, and the like.

The optical processing module 103 may communicate with the optical processing module 203 through a first optical path 30 and a second optical path 40. Specifically, the network device 10 may send first resonant light or second resonant light to the terminal 20 through the first optical path 30, where the first resonant light is used to carry information, and the second resonant light is used for charging. The terminal 20 may send the first resonant light or the second resonant light to the network device 10 through the second optical path 40.

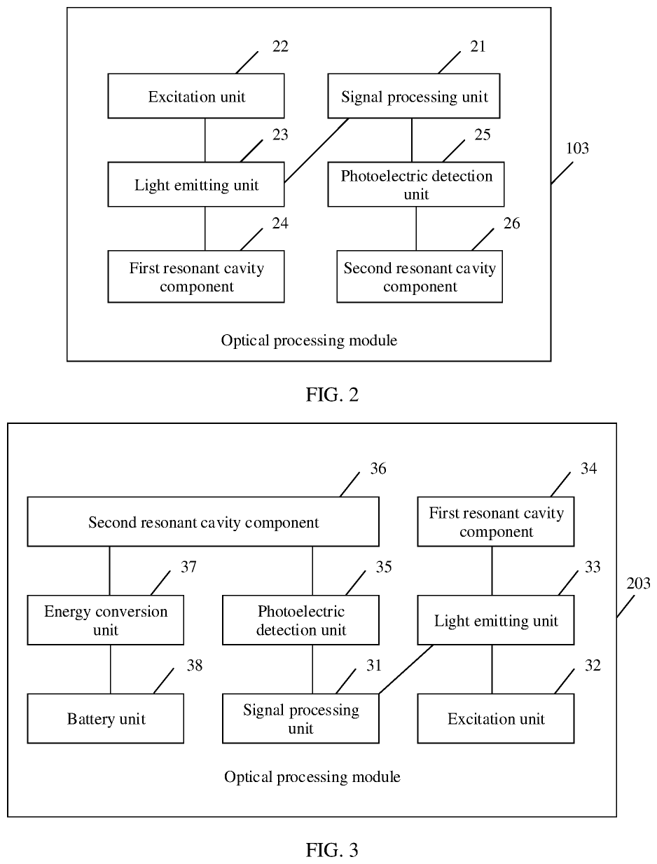

Refer to FIG. 2. In an embodiment, the optical processing module 103 may include a signal processing unit 21, an excitation unit 22, a light emitting unit 23, a first resonant cavity component 24, a photoelectric detection unit 25, and a second resonant cavity component 26. The light emitting unit 23 may include but is not limited to an optical modulator and an optical transmitting antenna. The first resonant cavity component 24 may be a total reflection mirror. The second resonant cavity component 26 may be a partial reflection mirror (for example, a semi-reflector). It should be noted that, the light emitting unit 23 and the first resonant cavity component 24 may be independent, or may be integrated together. The optical processing module 103 may further include an energy conversion unit and a battery unit.

Refer to FIG. 3. In an embodiment, an optical processing module 203 may include a signal processing unit 31, an excitation unit 32, a light emitting unit 33, a first resonant cavity component 34, a photoelectric detection unit 35, a second resonant cavity component 36, an energy conversion unit 37, and a battery unit 38. The light emitting unit 33 may include but is not limited to an optical modulator and an optical transmitting antenna. The first resonant cavity component 34 may be a total reflection mirror. The second resonant cavity component 36 may be a partial reflection mirror (for example, a semi-reflector). It should be noted that, the light emitting unit 33 and the first resonant cavity component 34 may be independent, or may be integrated together. The network device 10 and the terminal 20 may further include other components such as an optical filter. This is not limited in this application.

The first resonant cavity component 24 of the network device and the second resonant cavity component 36 of the terminal form an open resonant cavity, and the second resonant cavity component 26 of the network device and the first resonant cavity component 34 of the terminal form an open resonant cavity.

In a downlink data sending process, an optical modulator of the light emitting unit 23 modulates a data signal from the signal processing unit 21 and light from the excitation unit 22, and transmits the modulated light by using an optical transmitting antenna. After being emitted from the first resonant cavity component 24, the light is input into the second resonant cavity component 36 of the terminal to form laser light. The photoelectric detection unit 35 converts the laser light into an electrical signal. The signal processing unit 31 demodulates the electrical signal to obtain a data signal.

In an uplink data sending process, an optical modulator of the light emitting unit 33 modulates a data signal from the signal processing unit 31 and light from the excitation unit 32, and transmits the modulated light by using an optical transmitting antenna. After being emitted from the first resonant cavity component 34, the light is input into the second resonant cavity component 26 of the terminal to form laser light. The photoelectric detection unit 25 converts the laser light into an electrical signal. The signal processing unit 21 demodulates the electrical signal to obtain a data signal.

In a charging process, light generated by the excitation unit 22 is converted into resonant light by the light emitting unit 23, and then the resonant light is emitted from the first resonant cavity component 24. The resonant light is input into the second resonant cavity component 36 to form laser light, and the laser light enters the energy conversion unit 37. The energy conversion unit 37 converts the laser light into electric energy, and then the battery unit 38 stores the electric energy.

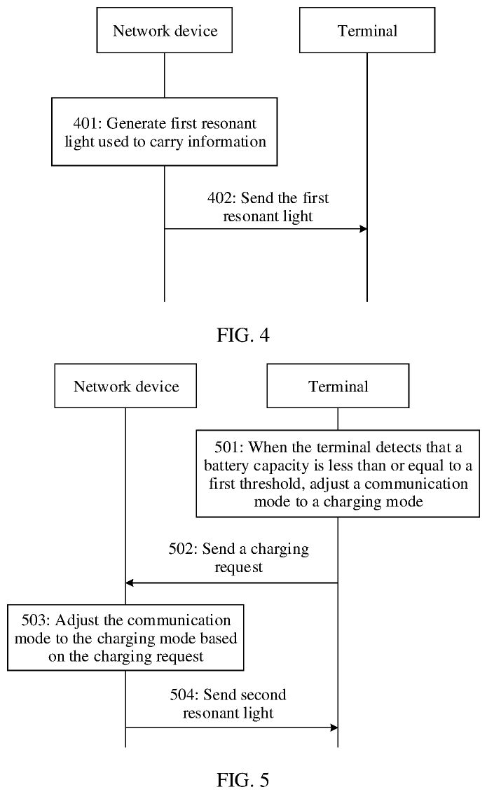

In a current wireless optical communication method, LED light can hardly meet a requirement of high-speed transmission. To improve a signal transmission rate, a laser light-based wireless optical communication method is used in this application. The following describes the method. Refer to FIG. 4. An embodiment of a wireless optical communication method in this application includes the following steps.

Step 401: A network device generates first resonant light used to carry information.

The first resonant light is used to carry the information, and the information may be instructions, data, or the like. The first resonant light may be obtained by modulating information and light of several wavelengths, and light of each wavelength is used as an independent information channel. Each information channel may be used as a channel for transmitting data. Therefore, data carried by resonant light can be greatly improved through resonant light multiplexing.

Step 402: The network device sends the first resonant light to a terminal by using a resonant cavity component.

In this embodiment, the resonant cavity component of the network device and a resonant cavity component of the terminal may form an open resonant cavity. After light emitted by the network device and the terminal resonates in the open resonant cavity, the light is emitted from an output end of the open resonant cavity to form laser light. A receive end of the open resonant cavity may obtain the laser light by using a photoelectric detection unit, and demodulate the laser light to obtain information carried in the laser light. Because an available bandwidth of resonant light is far greater than an available bandwidth of LED light, an information transmission rate may be greatly improved through resonant light multiplexing, and a transmission rate may reach more than 100 Gbps.

Second, brightness of resonant light in the open resonant cavity is far less than brightness of laser light. Therefore, a damage level of the resonant light cannot be calculated based on a damage level of the laser light. In terms of communication and charging, the resonant light is safer than the laser light. This helps protect human eyes.

In an optional embodiment, the wireless optical communication method further includes: The network device sends second resonant light to the terminal by using the resonant cavity component, where the second resonant light is used for charging.

The first resonant light and the second resonant light are at different time intervals. A unit of a time interval may be a slot, a subframe, a frame, a millisecond, a second, a minute, an hour, or the like. A length of the time interval may be one or more slots, one or more subframes, one or more frames, one or more milliseconds, one or more seconds, one or more minutes, or one or more hours. This may be specifically set based on an actual requirement, and is not limited herein.

In this embodiment, the network device sends the first resonant light and the second resonant light at different time intervals. In this way, the network device may implement two functions: a communication function and a charging function by using time division multiplexing of the resonant light, and the two functions may be implemented by using a same resonant cavity. It should be noted that power for sending the first resonant light is lower than power for sending the second resonant light, and the network device needs to be in different light emitting modes when sending the first resonant light and the second resonant light. Specifically, the network device needs to send the first resonant light in a communication mode, and the network device needs to send the second resonant light in a charging mode. Similarly, the terminal also needs to send the first resonant light in the communication mode, and the terminal needs to send the second resonant light in the charging mode.

Refer to FIG. 5. Another embodiment of a wireless optical communication method provided in this application includes the following steps.

Step 501: When a terminal detects that a battery capacity is less than or equal to a first threshold, the terminal adjusts a communication mode to a charging mode.

When the terminal detects that the battery capacity is less than or equal to the first threshold, it indicates that a current battery capacity is excessively low, and terminal cannot support the communication function.

Step 502: The terminal sends a charging request to a network device.

The charging request indicates the network device to adjust the communication mode to the charging mode. The charging request may carry information about the current battery capacity of the terminal.

Step 503: The network device adjusts the communication mode to the charging mode based on the charging request.

When both of the terminal and the network device are configured to be in the charging mode, the network device and the terminal perform a charging alignment operation, and the terminal may halt a component (for example, a photoelectric detection unit) related to the communication function, and start a charging module (for example, an energy detection module).

Step 504: The network device sends second resonant light to the terminal by using a resonant cavity component.

In this embodiment, after receiving the charging request sent by the terminal, the network device adjusts the communication mode to the charging mode based on the charging request, and then sends the second resonant light to the terminal, to charge the terminal. In this way, automatic charging is performed when a battery capacity is insufficient, and user experience is improved.

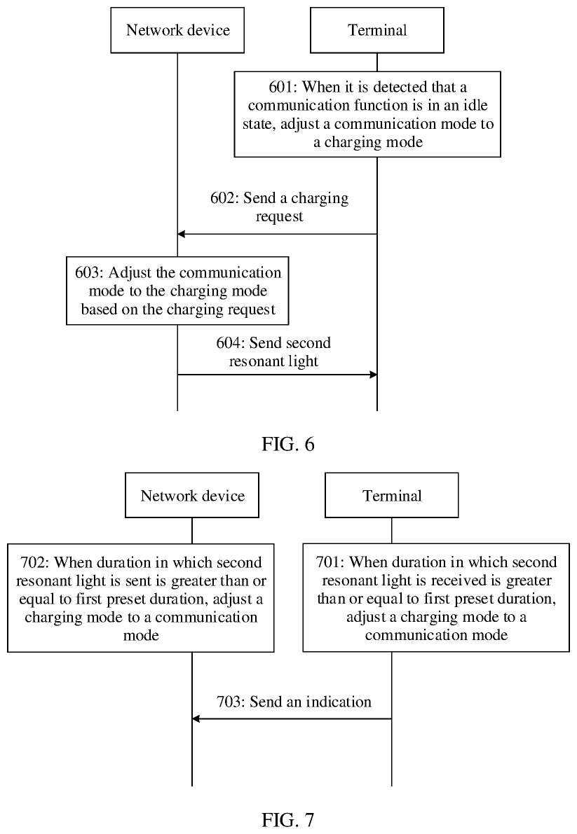

Refer to FIG. 6. Another embodiment of a wireless optical communication method provided in this application includes the following steps.

Step 601: When a terminal detects that a communication function is in an idle state, the terminal adjusts a communication mode to a charging mode.

Step 602: The terminal sends a charging request to a network device.

The charging request indicates the network device to adjust the communication mode to the charging mode.

Step 603: The network device adjusts the communication mode to the charging mode based on the charging request.

Step 604: The network device sends second resonant light to the terminal by using a resonant cavity component.

In this embodiment, after receiving the charging request sent by the terminal, the network device adjusts the communication mode to the charging mode based on the charging request, and then sends the second resonant light to the terminal, to charge the terminal. In this way, the terminal can be automatically charged when not performing communication, so that a battery life of the terminal is improved, and user experience is improved.

Refer to FIG. 7. Another embodiment of a wireless optical communication method provided in this application includes the following steps.

Step 701: When duration in which a terminal receives second resonant light is greater than or equal to first preset duration, the terminal adjusts a charging mode to a communication mode.

In this embodiment, the first preset duration may be charging duration in which a battery capacity of the terminal is from a first threshold to a second threshold. When the battery capacity is less than or equal to the first threshold, the battery capacity is insufficient to support a communication function. When the battery capacity is greater than the first threshold, the battery capacity can support the communication function. When the battery capacity is greater than or equal to the second threshold, it indicates that charging is completed. Alternatively, the first preset duration may be charging duration in which the battery capacity of the terminal is from zero to the second threshold, or may be a value that is set based on an actual situation. This is not limited herein.

When the duration in which the terminal receives the second resonant light is greater than or equal to the first preset duration, it indicates that charging is completed.

Step 702: When duration in which a network device sends second resonant light is greater than or equal to the first preset duration, the network device adjusts a charging mode to a communication mode.

In step 701 and step 702, the step in which the terminal adjusts the charging mode to the communication mode and the step in which the network device adjusts the charging mode to the communication mode are performed synchronously. It should be noted that the foregoing two steps may alternatively be performed asynchronously, and a specific sequence is not limited.

Step 703: The terminal sends an indication to the network device. The indication indicates that the terminal is in the communication mode.

After receiving the indication sent by the terminal, the network device may communicate with the terminal.

In this embodiment, the network device and the terminal may adjust a light emitting mode to the communication mode, and then the network device and the terminal may transmit data through resonant light. In this way, charging is automatically stopped when a battery capacity is sufficient, to reduce invalid power consumption.

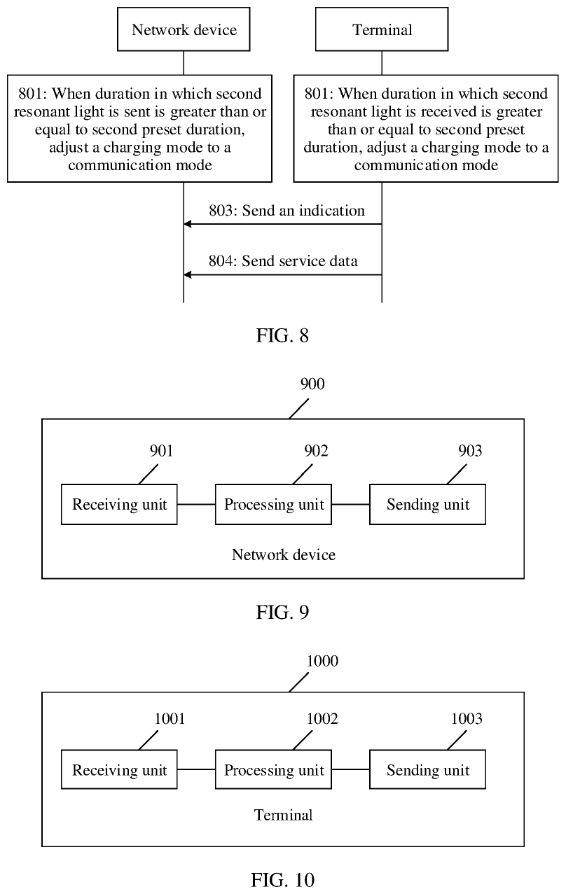

Refer to FIG. 8. Another embodiment of a wireless optical communication method provided in this application includes the following steps.

Step 801: When duration in which a terminal receives second resonant light is greater than or equal to second preset duration, the terminal adjusts a charging mode to a communication mode.

When the duration in which the terminal receives the second resonant light is greater than or equal to the second preset duration, it indicates that a battery capacity of the terminal is greater than a first threshold, and can support a communication function. When the duration in which the terminal receives the second resonant light is less than the second preset duration, it indicates that the battery capacity of the terminal cannot support the communication function.

Step 802: When duration in which a network device sends second resonant light is greater than or equal to second preset duration, the network device adjusts a charging mode to a communication mode.

In step 801 and step 802, the step in which the terminal adjusts the charging mode to the communication mode and the step in which the network device adjusts the charging mode to the communication mode are performed synchronously. It should be noted that the foregoing two steps may alternatively be performed asynchronously, and a specific sequence is not limited.

Step 803: The terminal sends an indication to the network device when service data needs to be sent.

The indication indicates that the terminal is in the communication mode.

Step 804: The terminal sends the service data to the network device by using a resonant cavity component.

After sending the indication, the terminal sends the service data to the network device.

Optionally, after receiving the indication, the network device may send an adjustment completion message to the terminal, and the terminal sends the service data to the network device based on the received adjustment completion message.

In this embodiment, after charging duration is greater than or equal to the second preset duration, the network device and the terminal may adjust the charging mode to the communication mode, and then communicate according to the indication. In this way, both of a charging requirement and a communication requirement are considered, and user experience is improved.

This application provides a network device that can implement the steps performed by the network device in any one of embodiments shown in FIG. 4 to FIG. 8. Refer to FIG. 9. In an embodiment, a network device 900 includes a receiving unit 901, a processing unit 902, and a sending unit 903, where both of the receiving unit 901 and the sending unit 903 include a resonant cavity component.

The processing unit 902 is configured to generate first resonant light used to carry information.

The sending unit 903 is configured to send the first resonant light to a terminal by using the resonant cavity component, where a resonant cavity component of the network device 900 and a resonant cavity component of the terminal form an open resonant cavity.

In an optional embodiment, the sending unit 903 is further configured to send second resonant light to the terminal, where the second resonant light is used for charging.

In another optional embodiment, the first resonant light and the second resonant light are at different time intervals.

In another optional embodiment, the receiving unit 901 is further configured to: before the network device sends the second resonant light to the terminal, receive a charging request sent by the terminal, where the charging request is sent by the terminal when a battery capacity is less than or equal to a first threshold.

The processing unit 902 is further configured to adjust a communication mode to a charging mode based on the charging request.

In another optional embodiment, the receiving unit 901 is further configured to: before the network device sends the second resonant light to the terminal, receive a charging request sent by the terminal, where the charging request is sent by the terminal when a communication function is in an idle state.

The processing unit 902 is further configured to adjust a communication mode to a charging mode based on the charging request.

In another optional embodiment, the processing unit 902 is further configured to: when duration in which the second resonant light is sent is greater than or equal to first preset duration, adjust a charging mode to a communication mode.

The receiving unit 901 is further configured to receive an indication sent by the terminal, where the indication indicates that the terminal is in the communication mode.

In another optional embodiment, the processing unit 902 is further configured to: when duration in which the second resonant light is sent is greater than or equal to second preset duration, adjust a charging mode to a communication mode.

The receiving unit 901 is further configured to receive an indication sent by the terminal, where the indication indicates that the terminal is in the communication mode.

The receiving unit 901 is further configured to receive service data sent by the terminal.

Refer to FIG. 10. In an embodiment, a terminal 1000 includes a receiving unit 1001, a processing unit 1002, and a sending unit 1003, where both of the receiving unit 1001 and the sending unit 1003 include a resonant cavity component.

The receiving unit 1001 is configured to receive first resonant light that is sent by a network device and that is used to carry information, where a resonant cavity component of the terminal and a resonant cavity component of the network device form an open resonant cavity.

In an optional embodiment, the receiving unit 1001 is further configured to receive second resonant light sent by the network device, where the second resonant light is used for charging.

In another optional embodiment, a processing unit 1002 is configured to: when a battery capacity is less than or equal to a first threshold, adjust a communication mode to a charging mode; and the sending unit 1003 is further configured to send a charging request to the network device, where the charging request indicates the network device to adjust the communication mode to the charging mode.

In another optional embodiment, a processing unit 1002 is configured to: when detecting that a communication function is in an idle state, adjust a communication mode to a charging mode.

The sending unit 1003 is further configured to send a charging request to the network device, where the charging request indicates the network device to adjust the communication mode to the charging mode.

In another optional embodiment, a processing unit 1002 is configured to: when duration in which the second resonant light is received is greater than or equal to first preset duration, adjust a charging mode to a communication mode.

The sending unit 1003 is further configured to send an indication to the network device, where the indication indicates the network device to adjust the charging mode to the communication mode.

In another optional embodiment, the processing unit 1002 is configured to: when duration in which the receiving unit 1001 receives the second resonant light is greater than or equal to second preset duration, adjust a charging mode to a communication mode.

The sending unit 1003 is further configured to send an indication to the network device when service data needs to be sent, where the indication indicates that the terminal is in the communication mode.

The sending unit 1003 is further configured to send the service data to the network device.

This application provides a wireless optical communication system, where the wireless optical communication system includes: a network device, configured to: generate first resonant light used to carry information; and send the first resonant light to a terminal, where a resonant cavity component of the network device and a resonant cavity component of the terminal form an open resonant cavity.

The terminal is configured to receive the first resonant light sent by the network device.

It should be noted that, content such as information exchange between the modules/units of the apparatus and the execution processes thereof is based on the same idea as the method embodiments of this application, and produces the same technical effects as the method embodiments of this application. For specific content, refer to the foregoing description in the method embodiments of this application. Details are not described herein again.

In addition, it should be noted that the described apparatus embodiment is an example. The units described as separate parts may or may not be physically separate, and parts displayed as units may or may not be physical units, may be located in one position, or may be distributed on a plurality of network units. Some or all of the modules may be selected based on actual needs to achieve the objectives of the solutions in this application. In addition, in the accompanying drawings of the apparatus embodiments provided in this application, connection relationships between modules indicate that the modules have communication connections with each other, and may be specifically implemented as one or more communication buses or signal cables.

This application provides a computer-readable storage medium. The computer-readable storage medium stores a computer program. When the computer program runs on a computer, the computer is enabled to perform the steps performed by the network device in any one of embodiments shown in FIG. 4 to FIG. 8. This application further provides a computer-readable storage medium. The computer-readable storage medium stores a computer program. When the computer program runs on a computer, the computer is enabled to perform the steps performed by the terminal in any one of embodiments shown in FIG. 4 to FIG. 8.

This application further provides a computer program product. When the computer program product is run on a computer, the computer is enabled to perform the steps performed by the network device in any one of embodiments shown in FIG. 4 to FIG. 8. This application further provides a computer program product. When the computer program product is run on a computer, the computer is enabled to perform the steps performed by the terminal in any one of embodiments shown in FIG. 4 to FIG. 8.

The network device in this application may be specifically a chip in a base station, and the chip includes a processing unit and a communication unit. The processing unit may be a processor, and the communication unit may be, for example, an input/output interface, a pin, or a circuit. The processing unit may execute computer execution instructions stored in a storage unit, to enable the base station to perform the wireless optical communication method in any one of embodiments shown in FIG. 4 to FIG. 8. Optionally, the storage unit is a storage unit in the chip, for example, a register or a cache. Alternatively, the storage unit may be a storage unit that is in a radio access device end and that is located outside the chip, for example, a read-only memory (ROM), another type of static storage device that can store static information and instructions, or a random access memory (RAM). The processor mentioned above may be a general-purpose central processing unit, a microprocessor, an application-specific integrated circuit (application specific integrated circuit, ASIC), or one or more integrated circuits configured to control program execution of the method in the first aspect.

It should be understood that, the processing unit mentioned in this application may be a central processing unit (CPU), or may be another general-purpose processor, a digital signal processor (DSP), an application-specific integrated circuit (Application Specific Integrated Circuit, ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It may be understood that the memory mentioned in embodiments of this application may be a volatile memory or a non-volatile memory, or may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitation, a plurality of forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct rambus RAM, DRRAM).

It should be noted that when the processor is a general-purpose processor, a DSP, an ASIC, an FPGA or another programmable logic device, a discrete gate, a transistor logic device, or a discrete hardware component, the memory (a storage module) is integrated into the processor. It should be noted that the memory described in this specification is intended to include but is not limited to the memories and any memory of another proper type.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program may be easily implemented by using corresponding hardware. Moreover, specific hardware structures used to achieve a same function may be in various forms, for example, in a form of an analog circuit, a digital circuit, or a dedicated circuit. However, for this application, a software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a server, a network device, or the like) to perform the methods in embodiments of this application.

All or some of the foregoing embodiments may be implemented by using software, hardware, firmware, or any combination thereof. When software is used to implement embodiments, all or some of embodiments may be implemented in a form of a computer program product.

The computer program product includes one or more computer instructions. When the computer program instructions are loaded and executed on the computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

The foregoing embodiments are merely intended to describe the technical solutions of this application, but not to limit this application. Although this application is described in detail with reference to the foregoing embodiments, a person of ordinary skill in the art should understand that modifications to the technical solutions recorded in the foregoing embodiments or equivalent replacements to some technical features thereof may still be made, without departing from the scope of the technical solutions of embodiments of this application.

What is claimed is:

1. A communication method comprising:
receiving, by a terminal from a network device using a resonant cavity component of the terminal, first resonant light carrying information, wherein the resonant cavity component of the terminal and a resonant cavity component of the network device form an open resonant cavity.

2. The method according to claim 1, wherein the method further comprises:
receiving, by the terminal using the resonant cavity component of the terminal, second resonant light sent by the network device, the second resonant light charging the terminal.

3. The method according to claim 2, wherein the method further comprises:
when the terminal detects that a battery capacity is less than or equal to a first threshold, adjusting, by the terminal, an operation mode of the terminal from a communication mode to a charging mode, and sending, by the terminal, a charging request to the network device, the charging request indicating the network device to adjust an operation mode of the network device from the communication mode to the charging mode.

4. The method according to claim 2, wherein the method further comprises:
when the terminal detects that a communication function of the terminal is in an idle state, adjusting, by the terminal, an operation mode of the terminal from a communication mode to a charging mode, and sending, by the terminal, a charging request to the network device, the charging request indicating the network device to adjust an operation mode of the network device from the communication mode to the charging mode.

5. The method according to claim 2, wherein after the receiving, by the terminal, the second resonant light sent by the network device, the method further comprises:
adjusting, by the terminal, an operation mode of the terminal from a charging mode to a communication mode when duration in which the second resonant light is received is greater than or equal to first preset duration; and
sending, by the terminal, an indication to the network device, the indication indicating that the terminal is in the communication mode.

6. The method according to claim 2, wherein the method further comprises:
adjusting, by the terminal, an operation mode of the terminal from a charging mode to a communication mode when duration in which the second resonant light is received is greater than or equal to second preset duration;
sending, by the terminal, an indication to the network device when service data is to be sent to the network device, the indication indicating that the terminal is in the communication mode; and
sending, by the terminal, the service data to the network device.

7. A terminal comprising a receiver, a processor, a transmitter, and a resonant cavity component; and
wherein the receiver is configured to receive first resonant light that is sent by a network device and that carries information, the resonant cavity component of the terminal and a resonant cavity component of the network device forming an open resonant cavity.

8. The terminal according to claim 7, wherein the receiver is further configured to receive, using the resonant cavity component of the terminal, second resonant light sent by the network device, the second resonant light charging the terminal.

9. The terminal according to claim 8, wherein
the processor is configured to: when a battery capacity is less than or equal to a first threshold, adjust an operation mode of the terminal from a communication mode to a charging mode; and
the transmitter is configured to send a charging request to the network device, the charging request indicating the network device to adjust an operation mode of the network device from the communication mode to the charging mode.

10. The terminal according to claim 8, wherein
the processor is configured to: when detecting that a communication function of the terminal is in an idle state, adjust an operation mode of the terminal from a communication mode to a charging mode; and
the transmitter is configured to: send a charging request to the network device, the charging request indicating the network device to adjust an operation mode of the network device from the communication mode to the charging mode.

11. The terminal according to claim 8, wherein
the processor is configured to: when duration in which the second resonant light is received by the receiver is greater than or equal to first preset duration, adjust an operation mode of the terminal from a charging mode to a communication mode; and
the transmitter is configured to: send an indication to the network device, the indication indicating that the terminal is in the communication mode.

12. The terminal according to claim 8, wherein
the processor is configured to: when duration in which the second resonant light is received by the receiver is greater than or equal to second preset duration, adjust an operation mode of the terminal from a charging mode to a communication mode; and
the transmitter is configured to: send an indication to the network device when service data is to be sent to the network device, the indication indicating that the terminal is in the communication mode; and send the service data to the network device.

13. A communication system, comprising:
a network device, configured to: generate first resonant light carrying information; and send the first resonant light to a terminal using a resonant cavity component of the network device, wherein the resonant cavity component of the network device and a resonant cavity component of the terminal form an open resonant cavity; and
the terminal is configured to receive the first resonant light sent by the network device using the resonant cavity component of the terminal.

14. The communication system according to claim 13, wherein
the network device is further configured to: send, using the resonant cavity component of the network device, second resonant light to the terminal to charge the terminal; and
the terminal is further configured to: receive the second resonant light sent by the network device.

15. The communication system according to claim 14, wherein the first resonant light and the second resonant light are sent in different time intervals.

16. The communication system according to claim 14, wherein
the network device is further configured to: before sending the second resonant light to the terminal, receive a charging request from the terminal, and adjust an operation mode of the network device from a communication mode to a charging mode based on the charging request; and
the terminal is further configured to: send the charging request to the network device when a battery capacity of the terminal is less than or equal to a first threshold, the charging request indicates the network device to adjust the operation mode of the network device to the charging mode.

17. The communication system according to claim 16, wherein the terminal is further configured to adjust an operation mode of the terminal from the communication mode to the charging mode when the battery capacity of the terminal is less than or equal to the first threshold.

18. The communication system according to claim 14, wherein
the network device is further configured to: receive a charging request from the terminal, and adjust an operation mode of the network device from a communication mode to a charging mode based on the charging request; and
the terminal is further configured to: send the charging request to the network device when a communication function of the terminal is in an idle state, the charging request indicates the network device to adjust the operation mode of the network device to the charging mode.

19. The communication system according to claim 14, wherein
the network device is further configured to: adjust an operation mode of the network device from a charging mode to a communication mode when duration in which the second resonant light is sent is greater than or equal to first preset duration, and receive an indication sent by the terminal, the indication indicating that the terminal is in the communication mode; and
the terminal is further configured to: adjust an operation mode of the terminal from the charging mode to the communication mode when duration in which the second resonant light is received is greater than or equal to the first preset duration, and send the indication to the network device.

20. The communication system according to claim 14, wherein
the network device is further configured to: adjust an operation mode of the network device from a charging mode to a communication mode when duration in which the second resonant light is sent is greater than or equal to second preset duration, receive an indication from the terminal, the indication indicating that the terminal is in the communication mode, and receive service data from the terminal after adjusting to the communication mode and receiving the indication; and
the terminal is further configured to: adjust an operation mode of the terminal from the charging mode to the communication mode when duration in which the second resonant light is received is greater than or equal to the second preset duration, send the indication to the network device when the service data is to be sent, and send the service data to the network device.
